(19) United States
(12) Patent Application Publication
(10) Pub. No.: US 2011/0086228 A1
(43) Pub. Date: Apr. 14, 2011

(54) Green-Colored Environmentally Inert Coated Materials, Barrier Compositions and Related Methods

(75) Inventors: Larry G. Oien, Ogden, IA (US); Stephen M. Loucks, Ames, IA (US); Robert J. Wampler, Ankeny, IA (US)

(73) Assignee: Becker Underwood, Inc., Ames, IA (US)

(21) Appl. No.: 12/575,764

(22) Filed: Oct. 8, 2009

(51) Int. Cl. B32B 27/38; B32B 19/04; B32B 17/06; B32B 15/08; B32B 13/04; B32B 15/04; B32B 21/04; B32B 27/36; B32B 27/40; B05D 3/02; B05D 3/00

(52) U.S. Cl. 428/413; 428/702; 428/432; 428/426; 428/454; 428/457; 428/469; 428/537.1; 428/480; 428/425.9; 427/372.2; 427/385.5; 427/389.7; 427/389.8

(57) ABSTRACT

Substantially environmentally inert materials that include substrates coated with a green-colored barrier layer containing at least a film forming polymer; organic pigment green 7; and yellow iron oxide pigment are disclosed. In the layer, the organic pigment green 7 and the yellow iron oxide pigment are present in the layer in a weight ratio of about 1:about 3 to about 1:about 5. Suitable substrates include crumb rubber, sand, chipped rubber and other particulate substrates. Related compositions, methods and recreation fields upon which such materials have been disposed are also described.

### BACKGROUND OF THE INVENTION

Athletic fields, such as football fields, soccer pitches, track, running tracks, playgrounds, “mini-golf” areas and other recreational fields are often covered in either natural turf (e.g., sod grass) or artificial turf. Artificial turf usually has a blade or projected fiber construction and often is supplemented by the addition of a base layer of ground cover that is interspersed or embedded among the blades or fibers. In the case of an athletic field, this ground cover is capable of absorbing the energy of impact of feet or other body parts making contact with the surface. These ground covers may include sand, mulch, or rubber or rubberized materials. For aesthetic reasons, it is desirable that the synthetic materials are green in color, to mimic the look of natural turf.

If the selected material is a rubber material, the surface materials/ground covers may be made of chipped or crumb rubbers, which are derived from the recycling of automotive and truck scrap tires. For example, crumb rubber is prepared by removing the steel portions and fluff is removed leaving the tire rubber with a granular consistency. The rubber is further processed with a granulator and/or cracker mill to reduce the size of the particles. Different sized particles may be used depending on the end application.

In many circumstances, the ground cover or surface material selected (including, crumb rubber, pebbles, mulches, etc.) may contain dangerous or toxic metals that leach from the material into the surrounding environment and/or emit volatile organic compounds (VOCs). The potential long term effects on the environment and/or the individuals who come in contact with these materials have recently become a concern.

In the context of recreational fields, athletic fields and landscape applications, it may be preferred to use ground cover that is green to mimic the color of natural grass, blend in with the artificial turf and/or other landscape plantings. When preparing green-colored ground cover and/or surface materials, conventional practice is to utilize either the organic pigment green 7 or chrome oxide green 17 individually to create a vibrant shade of green. Chrome oxide green 17 has generally been preferred from an economic perspective, as it is less costly than organic pigment green 7. However, chrome oxide green 17 contains levels of hexavalent chrome, which may create a health risk to humans, animals, and fish. Thus, any entity wishing to produce an environmentally friendly green-colored ground cover may be required to use organic pigment green 7, despite its high raw materials cost, which in some cases may be cost prohibitive.

Thus, there remains a need in the art for an environmentally friendly, non-toxic and cost effective green-colored coating that can be applied to surface materials and other substrates and act as a barrier to VOCs and metal leachates from the substrate.

### BRIEF SUMMARY OF THE INVENTION

Described and taught is green-colored barrier composition that, when applied to substrates to form a coating, reduces the emission of VOCs and/or metals leachates from the substrate; substantially environmentally inert materials that bear the barrier layer as a coating; and related methods.

Specifically, substantially environmentally inert materials that include substrates coated with a green-colored barrier layer containing at least a film forming polymer; organic pigment green 7; and yellow iron oxide pigment are disclosed. In the layer, the organic pigment green 7 and the yellow iron oxide pigment are present in a weight ratio of about 1:about 3 to about 1:about 5. Barrier compositions that form the layer (upon drying or curing operations) are taught.

Also disclosed are methods of substantially simultaneously (i) imparting a green color to and (ii) preventing the leaching of metals and/or the emission of VOCs from a substrate comprising coating the substrate with the green-colored barrier composition and drying or curing the composition, thereby forming a barrier layer. A recreational field that includes a demarcated geographic area upon which is disposed the substantially environmentally inert material as ground cover is also described.

### DETAILED DESCRIPTION OF THE INVENTION

The invention described addresses the challenges noted above by providing a substantially environmentally inert material that includes a substrate that is coated with a non-toxic, green-colored barrier layer. The invention also includes non-toxic, green-colored barrier compositions and methods of substantially simultaneously imparting a green color to and preventing the leaching of metals and/or the emissions of VOCs from a substrate by application of the barrier composition. Also included are recreational fields upon which the material is used as a cushioning ground cover.

By “substantially environmentally inert” it is meant that the material of the invention releases less metals leachate and/or emits less VOCs into the environment relative to materials that consist of the uncoated substrate. For example, the substantially environmentally inert material of the invention may exhibit a reduction in release of metals leachate in an amount of about 30% to about 90%, about 50% to about 85%, about 60% to about 80%, about 65% to about 75% less, when compared to the amount released by a similar material that is not coated with the barrier composition of the invention. Alternatively, or in addition to the reduction in metals leachate, the substantially inert material of the invention may exhibit a reduction in VOCs in an amount of about 30% to about 80%, about 50% to about 75%, and about 60% to about 70%, when compared to material that is not coated with the barrier composition of the invention. In either case, “reduction” may refer to reduction in release/emission of one compound or metal (e.g., reduction in xylene emissions or arsenic leachate) or of several compounds or metals, summed together.

By “metal leachate” it is meant the metals (as defined by the periodic table of elements) that are released or leached from the substrate material, such as, for example, arsenic, cadmium, chromium, lead, mercury, selenium, and/or zinc, without regard to form (e.g., elemental, ionized, or bonded to other moieties).

By volatile organic compounds or “VOC(s)”, it is meant any volatile organic compound having a sufficiently high vapor pressure such that it vaporizes and enters the atmosphere under ordinary conditions. Such compounds include, for example, chlorofluorocarbons, C₆₋₉ hydrocarbons, ethanol, acetone, carbon disulfide, cyclohexanone, tert-butanol, one-butanol, methylcyclohexane, xylene, N, N-dimethylacetamide, and/or methylacetate.

The substrate to which the barrier layer is applied to form the substantially environmentally inert material may be any material that one wishes to coat. It may contain a level of leachable metals and/or VOC(s). Exemplary substrate materials include rubbers, metals or metal alloys, cured polymers and copolymers, fill, sand, fibers, silica particles, talc, gravel, pebbles, asphalt, bituminous materials, and wood material.

In an embodiment where the substantially environmentally inert material has an end application as ground cover, it may be preferred that the substrate is crumb rubber or chipped rubber, either newly produced or recycled from waste rubber, such as tires. The substrate may take any format, for example, it may be in the form of a particle (particulate), a grain, a slab, a plank, a mat, a chip, and a sphere.

The substrate is coated with a green-colored barrier layer formed by application of the barrier composition. The term “green-colored” includes any hue of color that is perceived as green, regardless of saturation or brightness. In general this includes colors in the visible spectrum at wavelengths of about 520 to about 570 nm. Since greens that are perceived as yellow-tinted may be less aesthetically pleasing, it may be preferred that the green color of the barrier layer falls into the wavelength range of about 525 nm to about 550 nm or about 530 to about 540 nm (inclusive of endpoints). In may be preferred that in some embodiments the green hue selected is perceived by the human eye as more of a “Kelly green” or “Hunter green” than a yellow-hued green or chartreuse-type green.

The green-colored barrier layer includes a film forming polymer, organic pigment green 7, and yellow iron oxide pigment. As is understood by a person of ordinary skill in the art, organic pigment green 7, refers to the pigment identified as Chemical Abstract Service No. (CAS #) 1328-53-6, which is also referred to as “pigment green 7” or “copper phthalocyanine green 7” as having a chemical structure of C₃₂H₃Cl₁₃CuN₈ to C₃₂ HCl₁₅CuN₈. The pigment is available from numerous commercial outlets, including as a resin-based aqueous pigment dispersion sold under the product name Spectra Phthalo Green, available from Spectra Colorants, Inc., Union, S.C. 29373, USA.

As would have been understood by a person of ordinary skill in the art, yellow iron oxide pigment includes the pigment identified by CAS #51274-00-1 and is commonly referred to as “yellow iron oxide” or “yellow 42”. Any yellow iron oxide pigment may be used including, for example, any in the yellow to orange yellow range having a structure of α-FeOOH (goethite) with a diaspore crystal structure or a Y—FeOOH (lepidocrocite) with a boehmite crystal structure.

The proportion of yellow iron oxide pigment relative to that of organic pigment green 7 may be as high as possible while still conveying a green-colored hue to an observer. For example, the organic pigment green 7 and the yellow iron oxide pigment may be present in a weight ratio of about 1:about 3 to about 1:about 5; and of about 1:about 2 to about 1 to about 6.

The green-colored barrier layer also includes a film-forming polymer or copolymer (hereinafter collectively referred to as “polymer”). Such polymers may include any known in the art that are capable of developing a film when cured or dried. Suitable polymers may include, for example, maleic anhydride polymers, acrylic polymers (e.g., those made of one or more acrylate-based monomers), cellulose polymers, epoxies, urethane polymers, melamine polymers, etc.

The film forming polymer may be used in any amount and the proportion within the composition and layer will vary depending on the relative proportion(s) of pigments and other additives and the forms in which the other component(s) are delivered to the formulation (e.g., polymer dispersion, emulsions or neat). In some embodiments the film forming polymer is present in the composition (i.e., prior to the formation of a layer after drying or curing), in an amount of about are about 10% to 20% by weight, about 15% to about 25% by weight, about 25% to about 75% by weight of the overall composition.

Other additives or components may be included in the composition from which the green-colored barrier layer is ultimately formed. Additional additives may include, for example, additional polymers and copolymers, pigment dispersants, one or more rheology modifier(s), pH modifiers(s), anti-foaming agents, clays and other binders, fungicides, herbicides, carbon black and other fillers, and a biocide. The barrier composition may include at least one thickener or color enhancer/developer. Any suitable mineral filler or colloidal mineral suspensoid (collectively referred to herein as “mineral filler”) may be used. However, aluminum silicate, talc, smectite clays (synthetic or natural), such as bentonite, laponite, saponite, nontronite, or montmorillonite may be preferred. Small amounts of other pigments may be added to modify the shade, saturation, brightness and/or hue of the green.

In most circumstances, it may be preferred the composition exhibit several physical and chemical properties within certain parameters. For example:

| | |
|---|---|
| Density (obs/gal) | about 10 to about 15 |
| Theoretical Solids (% wt) | about 40 to about 70 |
| pH | about 8 to about 12 |
| Color Strength | about 90 to about 110 |
| Brookfield viscosity at 25° C. | about 400 to about 2500 |
| (spindle #2/20 rpm): | |

The composition may be applied to the substrate in any process, such as for example, dip coating, spray coating, immersion, toss/mix coating, painting, etc. In some instances, the coating may be applied under agitation to facilitate the formation of a layer of uniform thickness. If necessary, curing or post-application operations may be applied, such as heating, irradiating, pressurizing, etc.

The composition and formed barrier layer described above can be used in methods of substantially imparting a green color to and preventing the leaching of metals and/or the emission of VOCs from a substrate. Such aims may be accomplished substantially simultaneously by application of the barrier composition to the selected substrate and formation of a coating (by drying or curing the composition). Substrates may be articles such as the chipped rubber, crumb rubber, sand or gravel for use in a ground cover application or other articles (tools, vessels, tanks etc.). Alternatively, substrates may be fixed portions of a structure or dwelling (such as walls, pipes, etc.).

The substantially environmentally inert material described herein may be used in numerous applications. For example, the substantially environmentally inert material in a ground cover application may be disposed on an indoor or outdoor recreational fields or landscaped areas. Such fields can include, for example, football fields, running tracks, playgrounds, dog parks, soccer pitches, equestrian enclosures, polo grounds, baseball fields, areas where track and field events are carried out, schoolyards. The material may be disposed in a recreational field covered with artificial turf such that the material is interspersed among the projecting fibers or “blades” of artificial turf. The material may be left “loose” in this format or may be fixed in place by, for example, a heat treatment or adhesive.

In an embodiment, the invention includes a recreational field that includes a demarcated geographic area upon which is disposed a substantially environmentally inert material that comprises a substrate coated with green-colored barrier layer as described above. Demarcation may be by a physical structure, such as a wall, curb or pickets or merely by painted or inscribed or engraved lines. In this embodiment, the substrate is, preferably, for example, sand, rubber, chipped rubber, and/or gravel.

### Example 1

### Preparation of an Exemplary Formulation for Formation of the Green-Colored Barrier Layer

The components of Table 1 were combined and mixed for 30 minutes at 1400 rpm at ambient temperature, using a high speed dispersing blade. Subsequently, the components of Table 2 were added to the mixture and the entire formulation was mixed for 10 minutes at 400 rpm, at ambient temperature.

TABLE 1

| | Amount (weight percent |
|---|---|
| Component | of entire composition) |
| Iron oxide stabilizer (TAMOL ® 731 A) | 0.3 |
| Resin Pigment Dispersant Joncryl 678 @ 30% | 3 |
| active solids | |
| pH Modifier (monoisopropanolamine) | 0.9 |
| Antifoaming agent (DEE FO ® XHD 47J) | 0.02 |
| Yellow Iron Oxide Pigment 42 (Powdered) | 23 |
| Aluminum silicate | 1.5 |
| Water | 17 |

TAMOL® 731A is a proprietary formulation of a maleic anhydride copolymer, available from Rohm & Haas, Philadelphia, Pa. DEE FO® XHD 47J is a proprietary mixture of polysiloxane polymers available commercially from Munzing, Bloomfield, N.J. The aluminum silicate was obtained as a commercial product sold by BASF, Cranbury, N.J., USA, under the name “ASP 172”.

TABLE 2

| | Amount (weight percent |
|---|---|
| Component | of total composition) |
| Film-forming polymer (FULATEX ® 3822) | 17 |
| Rheology modifier (RHEOLATE ® 1) | 0.40 |
| Anti-foaming agent (DEE FO ® 3030) | 0.02 |
| Organic green pigment 7 (Spectra Phthalo | 8 |
| Green) | |
| Water | Q.S. |
| Total (Tables 1 & 2) | 100 |

FULATEX® 3822 is a proprietary maleic anhydride copolymer that us available from H.B. Fuller Company, Vadnais Heights, Minn. RHEOLATE® 1 is a proprietary acrylic emulsion in water available from Elementis Specialties, Highstown N.J., USA. DEE FOC 3030 is a proprietary mixture of polysiloxane polymers available commercially from Munzing, Bloomfield, N.J. Spectra Phthalo Green is a proprietary resin-based aqueous pigment dispersion available from Spectra Colorants, Union, S.C., USA.

The composition was a vivid kelly green hue.

### Example 2

### Preparation of an Exemplary Formulation for Formation of the Green-Colored Barrier Layer

The components of Table 3 were combined and mixed for 30 minutes high speed dispersion grind at 1400 rpm at ambient temperature. Subsequently, the components of Table 4 were added to the mixture and the entire formulation was mixed for 10 minutes at 400 rpm, at ambient temperature.

TABLE 3

| | Amount (weight percent |
|---|---|
| Component | of entire composition) |
| Resin Pigment Dispersant Joncryl 678 at 30% | 10 |
| active solids | |
| pH Modifier (monoisopropanolamine) | 1 |
| Antifoaming agent (DEE FO ® XHD 47J) | 0.05 |
| Yellow Iron Oxide Pigment 42 (How | 47 |
| delivered?) | |
| Carbon Black | 0.4 |
| Water | 21 |

DEE FO® XHD 47J is a proprietary mixture of polysiloxane polymers available commercially from H. B. Fuller Company, Vadnais Heights, Minn. Joncryl 678 is a proprietary mixture of acrylic resins available from BASF, Cranbury, N.J.

TABLE 4

| Component | Amount (weight percent) |
|---|---|
| Film-forming polymer (FULATEX ® 3822) | 10 |
| Rheology modifier (RHEOLATE ® 1) | 0.5 |
| Anti-foaming agent (DEE FO ® 3030) | 0.05 |
| Organic green pigment 7 (Spectra Phthalo | 5 |
| Green) | |
| Water | Q.S. |
| Total (Tables 3 & 4) | |

FULATEX® 3822 is a proprietary maleic anhydride copolymer that us available from H. B. Fuller Company, Vadnais Heights, Minn. RHEOLATE® 1 is a proprietary acrylic emulsion in water available from Elementis Specialties, Highstown N.J., USA. DEE FO® 3030 is a proprietary mixture of polysiloxane polymers available commercially from Munzing, Bloomfield, N.J. Spectra Phthalo Green is a proprietary resin-based aqueous pigment dispersion available from Spectra Colorants, Union, S.C., USA.

The resultant formulation was a vivid hunter green hue.

### Example 3

### Evaluation in the Reduction of VOCs Emitted by the Crumb Rubber Particles Bearing the Barrier Layer Versus Uncoated Crumb Rubber

Green-colored crumb rubber samples are prepared in the lab using a single coating on uncoated black crumb rubber at a rate of 3.85% color by weight on rubber. The samples are prepared in 1 gallon metal paint cans. 1000 grams of the crumb rubber is added to the paint can, then 38.5 grams of color is added evenly to the top surface of the rubber. The can is closed and is agitated on the paint shaker for 30 seconds, is removed from the shaker, is rolled 180 degrees, and is agitated for an additional 30 seconds. The colored rubber is then poured out in a thin layer on a piece of heavy paper and air dried. 300 g aliquots of these colored samples are tested. The uncoated crumb rubber is sampled straight from the raw material containers.

Coated samples and uncoated samples are weighed into headspace vials and spiked with an internal standard (benzene d6). The vials are sealed and heated to 150° F. for 1 hour. One ml of the headspace is analyzed by GC/MS. An average of three samples is used to calculate the relative reduction in VOC emissions as shown in Table 5:

TABLE 5

| VOC Analyte | % Reduction |
|---|---|
| MIBK | 80 |
| Ethanol | 45 |
| Acetone | 25 |
| Carbon disulfide | 70 |
| Cyclo hexanone | 90 |
| Tert-butanol | 75 |
| Methylcyclohexane | 70 |
| Xylene | 70 |
| N,N-dimethylacetamide | 70 |
| Methyl acetate | 70 |
| Other C_{6-g} hydrocarbons | 100% |

Overall, the average VOC reduction over the 12 compounds for which analysis is carried out is about 70% as compared to the VOCs emitted from uncured crumb rubber.

### Example 4

### Metals Leachate Testing

Testing is carried out in accordance with EPA method 1312. The samples are weighed into extraction vessels with extraction fluid at pH4.2. The vessels are sealed and rotated for 18 hours. The extraction fluid is analyzed. Using current analytical techniques, on a small scale, only zinc leachates levels are detectable. The zinc reduction was shown to be about 80.9%.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A substantially environmentally inert material that comprises a substrate coated with a green-colored barrier layer, wherein the barrier layer comprises:
a. a film forming polymer;
b. organic pigment green 7;
c. yellow iron oxide pigment;
wherein the organic pigment green 7 and the yellow iron oxide pigment are present in the layer in a weight ratio of about 1:about 3 to about 1:about 5.

2. The substantially environmentally inert material according to claim 1, wherein the organic pigment green 7 and the yellow iron oxide pigment are present in the layer in a weight ratio of about 1:about 2 to about 1:about 6.

3. The substantially environmentally inert material according to claim 1, wherein the substrate is chosen from a polymer, a sand grain, glass, metal, fiberglass, rubber, silica, talc, gravel, fill, and wood.

4. The substantially environmentally inert material according to claim 1, wherein the substrate is crumb rubber.

5. The substantially environmentally inert material according to claim 1, wherein the film forming polymer is chosen from a maleic anhydride polymer, an acrylic polymer, a cellulose polymer, an epoxy polymer, a urethane polymer, and a melamine polymer.

6. The substantially environmentally inert material according to claim 1, wherein the substrate is in a format chosen from a particle, a grain, a slab, a plank, a mat, a chip and a sphere.

7. The substantially environmentally inert material according to claim 1, wherein the barrier layer substantially reduces the emission of VOC(s) from the substrate compared to an uncoated material of the same substrate.

8. The substantially environmentally inert material according to claim 1, wherein the barrier layer reduces the emission of VOC(s) from the substrate by at least about 30% to about 90% compared to an uncoated material of the same substrate.

9. The substantially environmentally inert material according to claim 1, wherein the barrier layer reduces the emission of VOC(s) from the substrate by at least about 60% to about 80% compared to an uncoated material of the same substrate.

10. The substantially environmentally inert material according to claim 1, wherein the barrier layer reduces the metals leachate from the substrate by at least about 30% to about 80% compared to an uncoated material of the same substrate.

11. The substantially environmentally inert material according to claim 1, wherein the barrier layer further comprises one or more of an additive chosen from an additional polymer, a pigment dispersant, a rheology modifier, an antifoaming agent, a clay, a fungicide, a herbicide, carbon black, a thickener, a pH modifier, a crosslinking catalyst, and a biocide.

12. A green-colored barrier composition comprising:
a. a film forming polymer;
b. organic pigment green 7; and
c. yellow iron oxide pigment;
wherein the organic pigment green 7 and the yellow iron oxide pigment are present in the layer in a weight ratio of about 1:about 3 to about 1:about 5.

13. The barrier composition according to claim 12, wherein the film forming polymer is chosen from a maleic anhydride polymer, an acrylic polymer, a cellulose polymer, an epoxy polymer, a urethane polymer, and a melamine polymer.

14. The barrier composition according to claim 12, further comprises one or more of an additive chosen from an additional polymer, a pigment dispersant, a rheology modifier, an antifoaming agent, a clay, a thickener, a fungicide, an herbicide, carbon black, and a biocide.

15. A method of substantially simultaneously (i) imparting a green color to and (ii) preventing the leaching of metals and/or the emission of VOC(s) from a substrate comprising coating the substrate with a green-colored barrier composition that comprises:
a. a film forming polymer;
b. organic pigment green 7; and
c. yellow iron oxide pigment;
and drying or curing the composition, thereby forming a barrier layer,
wherein the organic pigment green 7 and the yellow iron oxide pigment are present in the composition in a weight ratio of about 1:about 3 to about 1:about 5.

16. The method according to claim 15, wherein the film forming polymer is chosen from a maleic anhydride polymer, an acrylic polymer, a cellulose polymer, an epoxy polymer, a urethane polymer, and a melamine polymer.

17. The method according to claim 15, wherein the coating further comprises one or more of an additive chosen from an additional polymer, a pigment dispersant, a rheology modifier, an antifoaming agent, a thickener, a fungicide, an herbicide, a pH modifier, a crosslinking catalyst, carbon black, and a biocide.

18. The method according to claim 15, wherein the formed barrier layer reduces the emission of VOC(s) from the substrate by at least about 30% to about 90% compared to an uncoated material of the same substrate.

19. The method according to claim 15, wherein the formed barrier layer reduces the metals leachate from the substrate by at least about 30% to about 90% compared to an uncoated material of the same substrate

20. An recreational field that comprises a demarcated geographic area upon which is disposed a ground cover that comprises a substantially environmentally inert material comprising a particulate substrate coated with a green-colored barrier layer, wherein the barrier layer comprises:
a. a film forming polymer;
b. organic pigment green 7; and
c. yellow iron oxide pigment;
wherein the organic pigment green 7 and the yellow iron oxide pigment are present in the composition in a weight ratio of about 1:about 3 to about 1:about 5.

21. The field of claim 20, wherein the particulate substrate is chosen from crumb rubber, sand, chipped rubber, and mulch.

22. The field of claim 20, wherein the field is chosen from a football field, a soccer pitch, a baseball field, a playground, a polo ground, and an equestrian enclosure.
